(19) United States
(12) Patent Application Publication
(10) Pub. No.: US 2007/0245036 A1
(43) Pub. Date: Oct. 18, 2007

(54) Illegal commands handling at the command decoder stage

(76) Inventor: Khaled Fekih-Romdhane, Houston, TX (US)

Correspondence Address: PATTERSON & SHERIDAN, LLP;Gero McClellan / Infineon / Qimonda, 3040 POST OAK BLVD.,, SUITE 1500, HOUSTON, TX, 77056, US

(21) Appl. No.: 11/368,179

(22) Filed: Mar. 3, 2006

(51) Int. Cl. G06F 3/00

(52) U.S. Cl. 710/5

(57) ABSTRACT

Embodiments of the invention provide a method and apparatus for detecting illegal commands. In one embodiment, the method includes receiving one or more first commands and recording a history of the received one or more first commands. The method also includes receiving one or more second commands at a command decoder and determining if the one or more second commands are illegal commands, wherein the history of the one or more received first commands is used to determine if the one or more second commands are illegal commands. If the one or more second commands are illegal commands, the command decoder is prevented from decoding and issuing decoded one or more second commands corresponding to the received one or more second commands.

### BACKGROUND OF THE INVENTION

1. Field of the Invention

The invention generally relates to handling illegal commands in a device.

2. Description of the Related Art

Modern computing devices typically contain a memory device (e.g., a dynamic, random access memory, or DRAM) for storing and retrieving data. In order to access data in the memory device (and to perform other operations in the memory device, such as refreshing stored data or modifying control registers within the memory device), commands may be issued as command signals via an interface to the memory device.

Decoder circuitry within the memory device may then decode the received command signals to obtain decoded commands. For example, for each command, the decoder circuitry may detect a certain combination of command signals which corresponds to the given command and provide a decoded command signal indicating that the given command was received. The decoded commands may then be latched, for example, using a command latch controlled by a command clock signal. The decoded commands may then be used by control circuitry to issue control signals within the memory device implementing the received commands. In some cases, an address may be provided along with the commands indicating a destination address for data being written to the memory device or a source address for data being read from the memory device. Where data is being written to the memory device, the data may be provided with the received command. Where data is being read from the memory device, the data may be retrieved from memory arrays on the memory device and placed in a buffer (e.g., a First In, First Out queue used for reading, referred to as a “read FIFO”).

In some cases, the memory device may have limited ability to perform certain sequences or combinations of received commands. For example, if the memory device has a single resource available to process a given command and if the resource can only process one command at a time then the memory device may be able to decode the received commands but may be unable to process two such commands if the commands are received within a given number of clock cycles of each other (e.g., while the resource is being used to execute the first command received in a first cycle, the resource may be unable to process the second command if it is received within a given number of cycles after the first cycle). In some cases, where the memory device is unable to process an issued command at a given time (e.g., due to a sequence of previously received commands), the command may be referred to as an illegal command. In other words, whether a command is illegal may depend on preceding commands.

In some cases, issuing an illegal command to a memory device may cause the memory device to enter into an undefined mode, e.g., the memory device may malfunction and become unresponsive to issued commands. Where the memory device enters an undefined mode, a chip reset may be required to restore the memory device to normal functionality (for example, if the memory device hangs up) and the chip reset may disrupt system operation (e.g., causing other devices which access the memory device to lose data and/or wait while the memory device is reset).

In order to avoid improper functioning of the memory device due to receiving an illegal command, some memory devices may attempt to cancel illegal commands after control circuitry in the memory device has issued control signals within the memory device implementing the received commands. Some memory devices may also attempt to cancel illegal read commands after the read data has been placed in the read FIFO. However, attempting to cancel illegal commands after control circuitry has issued control signals implementing the received commands may cause malfunction of the control circuitry (e.g., because control circuitry may be interrupted while the illegal commands are already being processed). Also, attempting to cancel illegal commands after read data has been placed in the read FIFO may cause disruption of the read FIFO (e.g., data in the read FIFO for succeeding read commands to be corrupted). For example, the FIFO may have a counter which tracks which data are being read from the FIFO. Attempting to cancel an illegal command after read data has been placed in the read FIFO may cause the counting sequence of the counter to be disrupted, thereby disrupting data subsequently read from the read FIFO.

Accordingly, what is needed are improved methods and apparatus for handling illegal commands.

### SUMMARY OF THE INVENTION

Embodiments of the invention generally provide a method and apparatus for detecting illegal commands. In one embodiment, the method includes receiving one or more first commands and recording a history of the received one or more first commands. The method also includes receiving one or more second commands at a command decoder and determining if the one or more second commands are illegal commands, wherein the history of the one or more received first commands is used to determine if the one or more second commands are illegal commands. If the one or more second commands are illegal commands, the command decoder is prevented from decoding and issuing decoded one or more second commands corresponding to the received one or more second commands.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary memory device according to one embodiment of the invention.

FIG. 2 is a flow diagram depicting a process for detecting illegal commands at the command decoder stage according to one embodiment of the invention.

FIGS. 3A-E are block diagrams depicting exemplary command history circuitry according to one embodiment of the invention.

FIG. 4 is a block diagram depicting an exemplary command decoder and illegal command detect circuitry according to one embodiment of the invention.

FIG. 5 is a block diagram depicting exemplary illegal command detect circuitry according to one embodiment of the invention.

FIG. 6 is a block diagram depicting exemplary read and write command detect circuitry in a command decoder according to one embodiment of the invention.

### DETAILED DESCRIPTION OF THE PREFERRED EMBODIMENT

Embodiments of the invention generally provide a method and apparatus for detecting illegal commands. In one embodiment, the method includes receiving one or more first commands and recording a history of the received one or more first commands. The method also includes receiving one or more second commands at a command decoder and determining if the one or more second commands are illegal commands, wherein the history of the one or more received first commands is used to determine if the one or more second commands are illegal commands. Illegal commands may be considered illegal with respect to the current state of the receiving device, and the state of the receiving device may be determined, for example, by previous commands received by the device. If the one or more second commands are illegal commands, the command decoder is prevented from decoding and issuing decoded one or more second commands corresponding to the received one or more second commands. By preventing the command decoder from decoding and issuing the decoded one or more second commands, other circuitry (e.g., control circuitry) may not receive or attempt to implement the received illegal commands. Because the other circuitry does not receive or attempt to implement the illegal commands, the other circuitry may be prevented from possibly malfunctioning because of the illegal commands (e.g., by entering into an undefined state which may require a system reset to restore functionality).

An Exemplary Memory Device

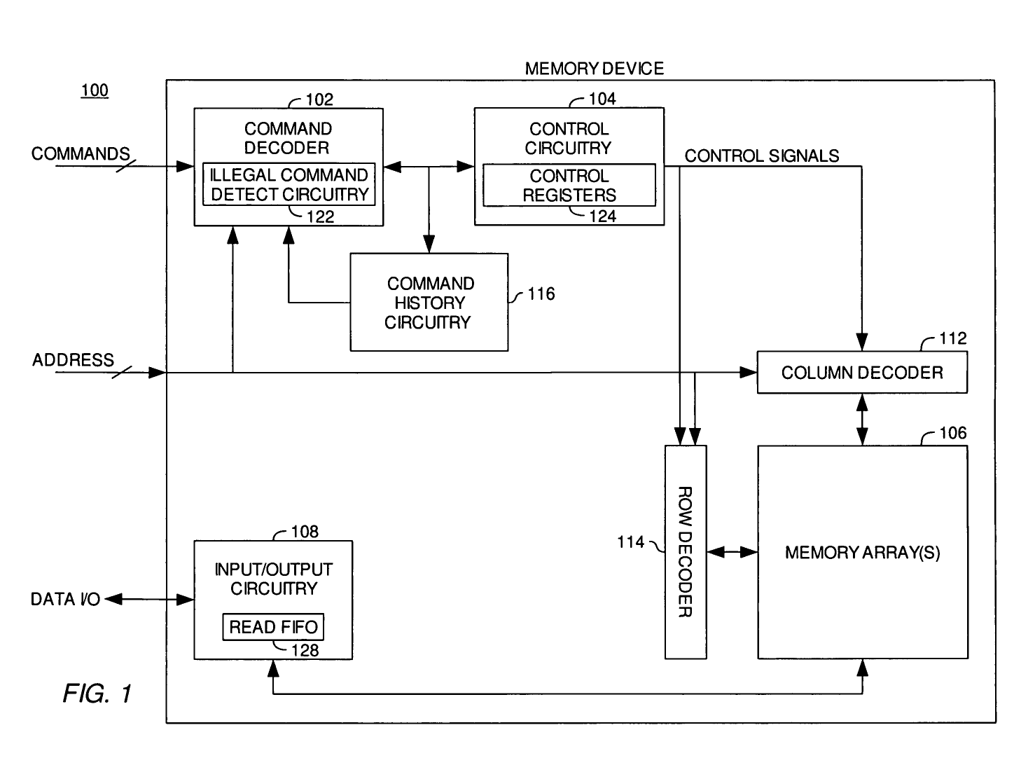

FIG. 1 is a block diagram depicting an exemplary memory device 100 according to one embodiment of the invention. As depicted, the memory device 100 may include a command decoder 102, control circuitry 104, memory array 106 (or memory arrays 106 for some embodiments), and input/output (I/O) circuitry 108.

As described in greater detail below, the command decoder 102 may receive command signals on a command bus and decode the command signals to identify received commands. The decoded commands may then be sent to control circuitry 104 which generates internal control signals. The control circuitry 104 may also contain control registers 124 which may be used to change the mode of operation or other operating characteristics of the memory device 100. In some cases, such control registers 124 may be read from and/or written to by devices accessing the memory device 100.

The control signals generated by the control circuitry 104 may be issued to circuitry in the memory device 100 which may include a column decoder 112 and a row decoder 114. The column decoder 112 and the row decoder 114 may utilize the control signals in addition to an address supplied to the memory device 100 to access the memory array 106. Data from the memory array 106 may be input or output via I/O circuitry 108. For example, data being read from the memory array 106 may be placed in a read first in/first out queue (FIFO) 128 before being output by the I/O circuitry 128.

In one embodiment of the invention, the memory 100 may contain command history circuitry 116 which may be utilized to record a history of one or more previously received commands. As described below, the history of previously received commands (e.g., the history of a received sequence of commands) may then be used by illegal command detect circuitry 122 to detect illegal commands in the command decoder 102, e.g., before the illegal commands are decoded and issued to the control circuitry 104. In some cases, legality or illegality of commands (or sequences of commands) may be determined, for example, by the designer of the memory device 100. For example, in some cases, if a read command is received by the memory device 100, it may be illegal to issue subsequent read commands to the memory device 100 within a set number of clock cycles (e.g., during the subsequent clock cycle, or during the subsequent two clock cycles). Also, in one embodiment, which commands (or sequences of commands) are legal may be described by an industry specification such as a Joint Electron Device Engineering Council (JEDEC) standard (e.g., the JEDEC standard for DDR SDRAM, JEDEC Standard 79 (JESD-79D), “Double Data Rate (DDR) SDRAM Specification”, published February 2004, or the JEDEC standard for DDR2 SDRAM, JESD-79-2B, “DDR2 SDRAM Specification”, published January 2005).

Detecting Illegal Commands at the Command Decoder Stage

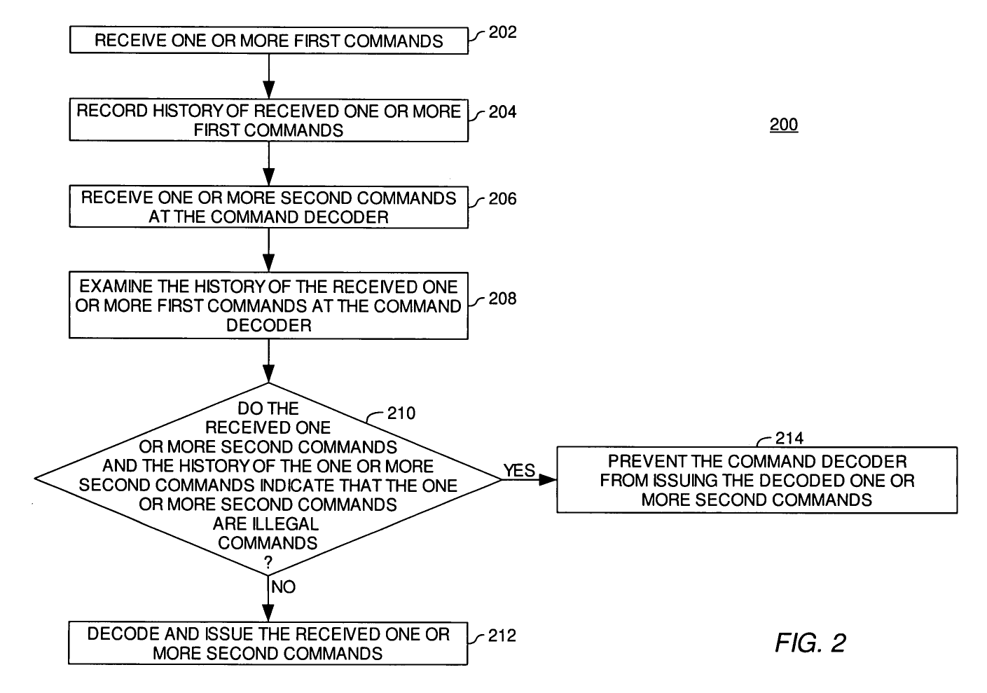

FIG. 2 is a flow diagram depicting a process 200 for detecting illegal commands at the command decoder stage according to one embodiment of the invention. The process 200 may begin at step 202 where one or more first commands are received. At step 204, the history of the received one or more first commands may be recorded, e.g., using command history circuitry 116. At step 206, one or more second commands may be received by the command decoder 102.

At step 208, the command decoder may examine the history of the received one or more first commands. For example, signal indicating the history of the received one or more first commands may be issued by the command history circuitry 116 and received by the command decoder 102. At step 210, a determination may be made of whether the received one or more second commands and the history of the received one or more first commands indicates that the received one or more second commands are illegal commands. The determination may be made, as described below, using the illegal command detect circuitry 122.

If the determination is made that the one or more second commands are not illegal commands, then the command decoder 102 may decode and issue the received one or more second commands (e.g., as decoded one or more second commands) at step 212. In some cases, between decoding and issuing the commands, the decoded commands may be latched by command latches, for example, using a rising edge of a command clock signal, as described below. The decoded one or more second commands may then be issued, for example, to the control circuitry 104 which may then issue control signals to other circuitry in the memory device 100 implementing the one or more second commands.

If however, the determination is made that the one or more second commands are illegal commands, then the command decoder 102 may be prevented from issuing the decoded one or more second commands at step 214. By preventing the one or more second commands from being issued to the control circuitry 104 as decoded commands, the control circuitry 104 may be prevented from erroneously issuing control signals which implement the illegal commands, thereby preventing the memory device 100 from possibly entering an undefined mode and/or malfunctioning.

Exemplary Command History Circuitry

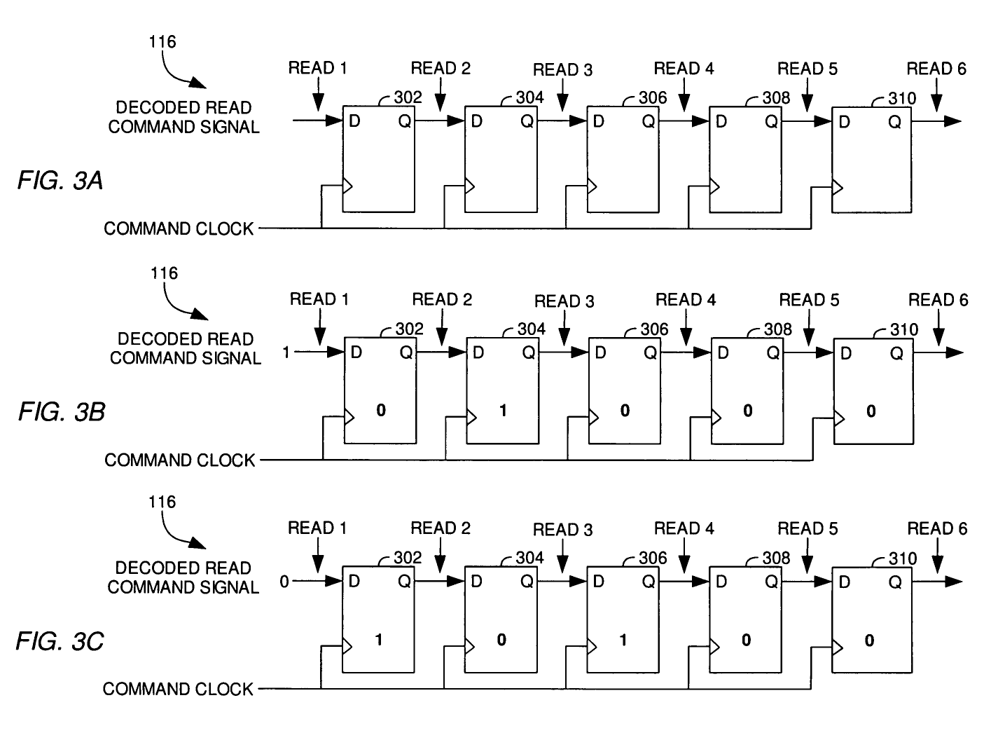

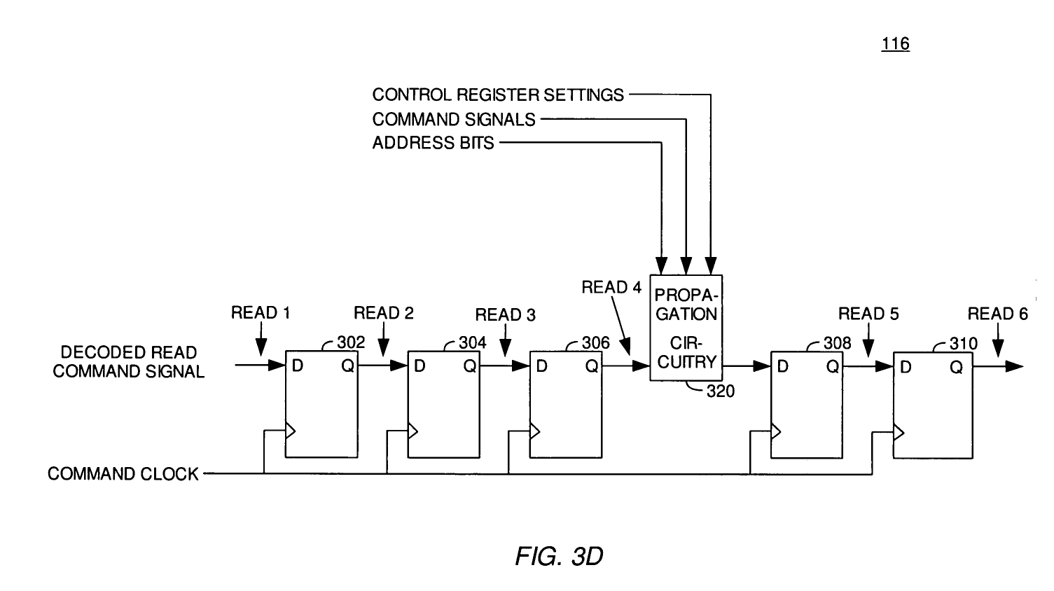

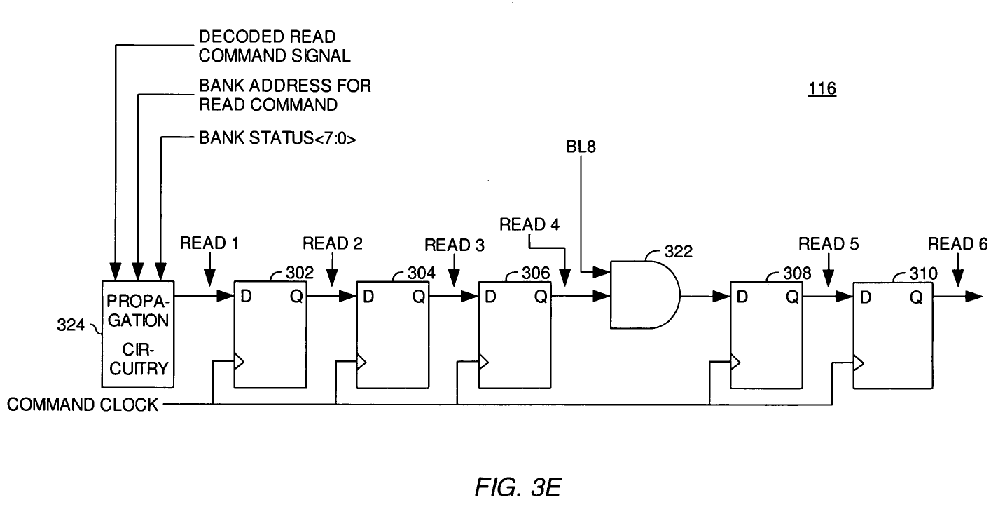

In one embodiment, to detect illegal commands, the history (e.g., a preceding sequence) of received commands may be recorded, for example, using command history circuitry 116. FIG. 3A is a block diagram depicting exemplary command history circuitry 116 according to one embodiment of the invention. For the examples depicted in FIGS. 3A-E, the command history circuitry 116 is used to record read commands. However, similar circuitry may be used to record the history of other commands such as write commands, refresh commands, and/or any other commands.

As depicted, the command history circuitry may include one or more latches 302, 304, 306, 308, 310 connected, for example, as a chain. The input to the first latch 302 may be a decoded read signal indicating that whether a read command has been received by the memory device 100 during a previous rising edge of a command clock signal (Read 1). The command clock signal may indicate when a command has been received (e.g., when a received set of command signals which satisfy the setup and hold time for commands issued to the memory device 100) and may be derived from the system clock. The output of the first latch 302 may be the input to the second latch 304, the output of the second latch 304 may be the input to the third latch 306, and so on. The clock input for each latch 302, 304, 306, 308, 310 may also be connected to the command clock signal. In some cases, the command clock signal may be the system clock signal for the memory device 100.

In one embodiment of the invention, each latch 302, 304, 306, 308, 310 in the command history circuitry 116 may indicate whether a given command was received during a certain preceding command clock cycle. For example, a signal received by the command history circuitry 116 (the read command signal) may indicate whether a read command was received during the previous clock cycle (Read 1), the output of the first latch 302 may indicate whether a read command was received two cycles previously (Read 2), the output of the second latch may indicate whether a read command was received three cycles previously (Read 3), and so on. In one embodiment, the command signals received by the command history circuitry 116 may be decoded command signals. Optionally, in one embodiment, the command signals recorded by the command history circuitry 116 may not be decoded. In some cases, the values stored in the latches 302, 304, 306, 308, 310 may be considered safety flags because the values may indicate whether or not it is safe (e.g., legal) to execute a received command. Also, as described below, propagation circuitry may be utilized to determine how long the values stored in the latches 302, 304, 306, 308, 310 should be maintained.

During each cycle of the command clock, the value stored in each latch 302, 304, 306, 308, 310 may be propagated to the next latch, such that the latches 302, 304, 306, 308, 310 towards the end of the chain of latches contain “older” received commands. For example, each time the command clock signal is detected, the first latch 302 may latch (e.g., record) the read command signal (if any) present at the input of the latch 302. Similarly, each time the command clock signal is detected, the second latch 304 may latch the value stored and output by the first latch 304, the third latch 306 may latch the value stored and output by the second latch 306, and so on for each of the latches 308, 310. In some cases, the command history circuitry 116 may be a shift register or a first-in, first-out queue (FIFO).

FIG. 3B is a block diagram depicting exemplary command information stored in the command history circuitry 116 according to one embodiment of the invention. As depicted, the second latch 304 may store the value ‘1’ indicating that a read command was received three cycles ago (Read 3). Also, the read command signal may be ‘1’, indicating that a read command was received one cycle previously. At some time later, after the command clock signal is received (e.g., during the next cycle), each value may be shifted one latch to the right, as indicated in FIG. 3C. Thus, the first latch 302 may contain the value ‘1’ indicating that a read signal was received two cycles ago (Read 2) and the third latch 306 may contain the value ‘1’ indicating that a read command was received four cycles ago (Read 4). Thus, during each command clock cycle, the stored command information in the command history circuitry 116 may be updated to reflect how recently the previous commands, if any, were received.

In some cases, additional logic may be utilized in the command history circuitry 116 to determine what information regarding commands is maintained in the command history circuitry 116. For example, where the command history is stored in a chain of latches 302, 304, 306, 308, 310, propagation circuitry may be utilized to determine whether the history of the commands signals is propagated through the latches 302, 304, 306, 308, 310. FIG. 3D is a block diagram depicting exemplary command history circuitry 116 with propagation circuitry 320 according to one embodiment of the invention.

As depicted, the propagation circuitry 320 may receive one or more signals including signals indicating mode register settings, command signals, and/or address bits. Based on the received signals, the propagation circuitry 320 may determine whether or not to propagate command signals stored in the command history circuitry 116. In some cases, the determination of whether to propagate command signals may be made depending on whether the signals received by the propagation circuitry 320 have an effect on the legality of commands being received by the memory device 100.

As an example of a signal received by the propagation circuitry 320 which affects the legality of commands received by the memory device, the control registers may contain a setting which changes the burst length of the memory device 100 for reading of data. If the control registers contain a first setting (e.g., a setting selected by commands issued to the memory device 100), the acceptable burst length may be four cycles, e.g., thereby allowing four sequential read commands to be received. If the control registers contain a second setting the acceptable burst length may be eight, e.g., thereby allowing eight sequential read commands to be received.

In some cases (for example, in DDR2 SDRAM), if a read command is received after an odd number of cycles from a previous, legal read command, then the received read command may be illegal. Such a received read command may be considered illegal, for example, because the received read command may interrupt an ongoing burst read. Furthermore, in some cases, because the burst length setting may be varied (e.g., the burst length setting may be four cycles or eight cycles), more command history may be stored for longer burst length settings (e.g., for a burst length setting of eight) than for shorter burst length settings (e.g., than for a burst length of four), for example, because the memory device 100 may be more sensitive to receiving a given sequence of read commands when the burst length is as large as eight.

As another example, the legality of a given read command may depend on whether a read command is issued on a closed bank. If a read command is issued on a closed bank, the read command is not legal, and does not, therefore, block succeeding read commands (e.g., because the illegal command is given no effect). Thus, when such an illegal read command is received, the command may not be propagated.

FIG. 3E is a block diagram depicting exemplary command history circuitry 116 which is dependent on a burst length and the legality of received read commands according to one embodiment of the invention.

As depicted, with respect to storage of command history dependent upon a burst length setting, an AND gate 322 may be inserted between the third latch 306 and the fourth latch 308. The propagation of stored signals between the third latch 306 and the fourth latch 308 is dependent on the inputs to the AND gate 322. The inputs to the AND gate 322 may be the command signal propagated from the third latch 306 and the burst length setting (BL8, where BL8 =‘1’ indicates that the burst length is eight). If the burst length setting is eight (BL8=‘1’), any signals received from the third latch 306 may be propagated to the fourth latch 308, thereby storing enough command history to determine if a received read command is illegal. If the burst length setting is four (BL8=‘0’), any signals received from the third latch 306 may not be propagated to the fourth latch 308 (e.g., because the output of the AND gate 322 is always ‘0’ where BL8=‘0’), thereby preventing irrelevant command signals (e.g., command signals older than four cycles which may have no effect on the legality of newly received read commands where the burst length is four) from being propagated in the command history circuitry 116.

Also as depicted in FIG. 3E, with respect to the storage of command history for illegal read commands, the command history circuitry 116 may contain propagation circuitry 324 which receives the read command signal Read 1 (indicating a read command was received one clock cycle ago from the current command clock cycle), a bank address corresponding to the read command signal, and the status of the each of the banks (e.g., open or closed for each of the eight banks <7:0>) in the memory device 100. If the bank address for a received read command and the status of the bank being accessed indicates that the accessed bank is closed, then the read command signal may not be propagated (Read 1=‘0’). If, however, the read command is not accessing a closed bank, then the read command signal may be propagated as described above (Read 1=‘1’). Also, in some cases, other read signals (e.g., Read 2, Read 3, etc.) stored in the chain of latches 302, 304, 306, 308, 310 may also be used for blocking other read signals (e.g., Read 1) from propagation in the chain of latches 302, 304, 306, 308, 310.

In one embodiment, the values stored in the chain of latches 302, 304, 306, 308, 310 may be cleared (e.g., reset) during power-up or a reset of the memory device 100. By clearing the latches 302, 304, 306, 308, 310 during power-up or reset of the memory device 100, the memory device 100 may prevent any initial, unintended data stored in the latches 302, 304, 306, 308, 310 from inadvertently being used to block commands received after power-up or reset of the memory device 100.

While described above with respect to command history which is dependent upon a burst length setting and/or the legality of a received command, any combination of control settings, command signals, address bits, and/or error signals may be used to determine whether command signals should be maintained in the command history circuitry 116. Also, while depicted with respect to propagation circuitry which controls command signal propagation from the third latch 306 to the fourth latch 308, appropriate circuitry may be utilized to affect the propagation of command signals to and/or from any of the depicted latches 302, 304, 306, 308, 310.

In addition, while described above with respect to latches 302, 304, 306, 308, 310 for storing read command history, embodiments of the invention may provide circuitry for storing the history of multiple types of commands (e.g., for write commands, refresh commands, and/or other commands). In some cases, other history data may also be stored by the command history circuitry, such as received address data. Furthermore, while described above with respect to latches 302, 304, 306, 308, 310 utilized to store command history, embodiments of the invention may also utilize other circuitry to record command history.

For example, counters may be used to record the history of received commands. Each time a command is received, the counter used to record the command history may be reset. Then, during each subsequent clock cycle, the counter may be incremented, thereby indicating how recently the command was received. Logic may also be provided which modifies and/or resets the count based on mode register settings, received commands, and/or address bits. Command history may also be recorded using any other convenient method and/or circuitry.

Exemplary Command Decoder

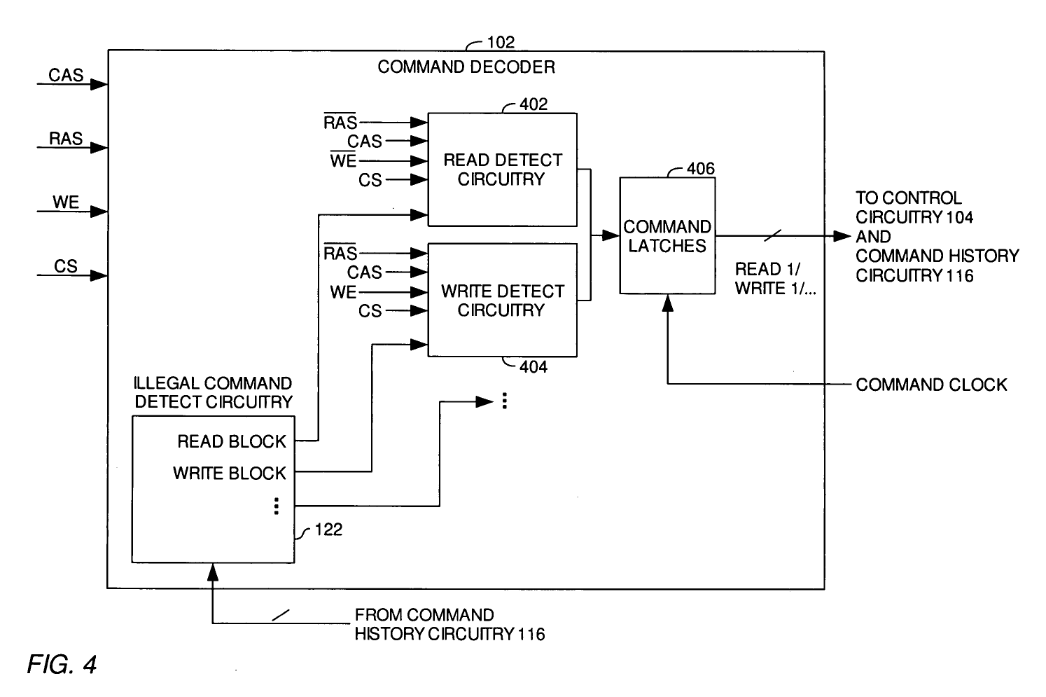

FIG. 4 is a block diagram depicting an exemplary command decoder 102 with illegal command detect circuitry 122 according to one embodiment of the invention.

In one embodiment of the invention, the illegal command detect circuitry 122 may be additional logic (e.g., transistors, gates, or other circuitry) added to the command decoder 102 to receive signals (e.g., from the command history circuitry 116) indicating the history of previously received commands. Depending on the command history and the received command, the illegal command detect circuitry 122 may either allow the decoded command to be provided by the command decoder 102 to other circuitry in the memory device 100 (e.g., the control circuitry 104) if the command is illegal or prevent the decoded command from being provided by the command decoder 102 if the command is illegal.

As depicted, the command decoder 102 may contain read detect circuitry 402 and write detect circuitry 404, as well as circuitry for detecting other commands. In some cases, the command decoder may receive commands, for example, via external command signals CAS (column address strobe), RAS (row address strobe), WE (write enable), and CS (chip select). The specific combination of external command signals may indicate whether a read command, write command, any other command, or no command is received by the memory device 100.

The external command signals (or inverted versions of the received command signals as indicated by the bar over the signal, e.g., RAS) may be applied to the read detect circuitry 402, the write detect circuitry 404, as well as other command detecting circuitry. If, for example, a read command is detected, the read detect circuitry 402 may assert a read command signal which is latched by command latches 406, e.g., on the rising edge of the command clock signal. Similarly, if a write command is detected, the write detect circuitry 404 may assert a write command signal which is latched by command latches 406. Other command detection circuitry may also be provided to detect and assert command signals for other commands. The latched read signals, write signals, and other command signals (e.g., Read 1, Write 1, and other command signals) may then be provided to the command circuitry 104 and/or the command history circuitry 116 as described above.

In one embodiment of the invention, the illegal command detect circuitry 122 may receive command history signals from the command history circuitry 116 and use the received command history signals to determine whether to block certain types of received commands (e.g., to determine whether to block any type of command which is illegal). To block a given type of command, the illegal command detect circuitry 122 may assert a command block signal. For example, the illegal command detect circuitry 122 may generate a read block signal, a write block signal, and other command blocking signals.

In one embodiment, the block signal for a given command may be received by the command detection circuitry for that command. Thus, the read detect circuitry 402 may receive the read block signal and the write detect circuitry 404 may receive the write block signal. When the command block signal is asserted, the command detection circuitry for that command may not decode any received commands of that type (e.g., when the command block signal is asserted, no decoded command signals for that command type may be asserted by the command detection circuitry). For example, when the read block signal is asserted, even though the read detect circuitry 402 may detect a read command issued to the memory device 100, the read detect circuitry may not assert a decoded read command signal, and the command latches 406 may not latch an asserted, decoded read command signal. Thus, no read command signal may be asserted to the control circuitry 104, thereby preventing the control circuitry 104 from improperly trying to execute the illegal, received read command. The write detect circuitry 404 and other command detection circuitry may also perform similar functions.

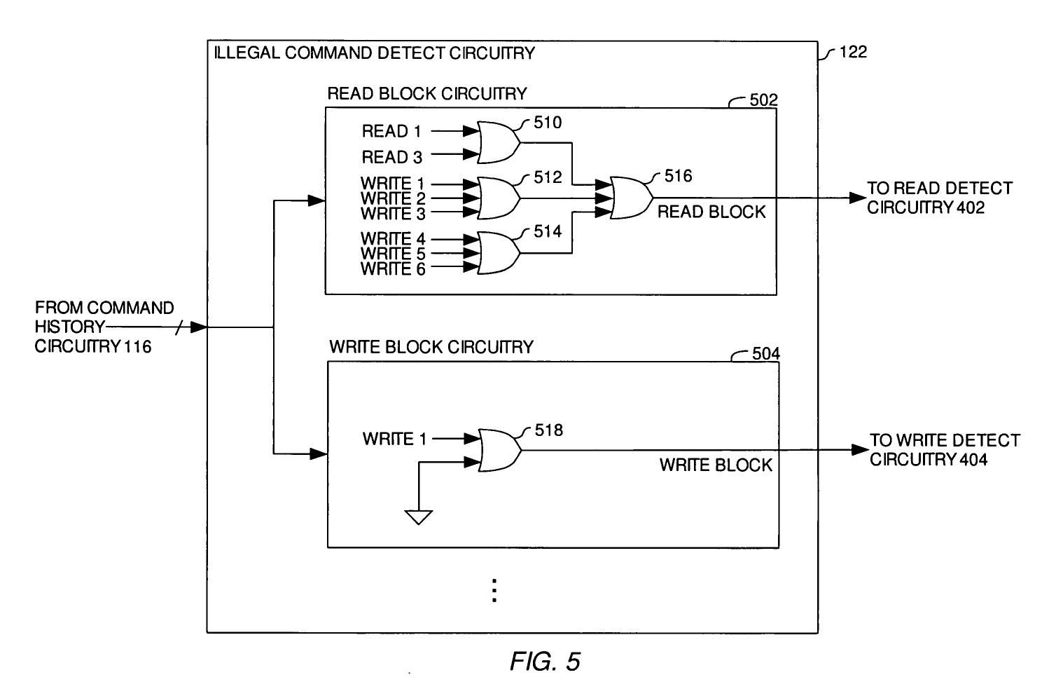

FIG. 5 is a block diagram depicting exemplary illegal command detect circuitry 122 according to one embodiment of the invention. As depicted, the illegal command detect circuitry 122 may contain read block circuitry 502 and write block circuitry 504, as well as other command blocking circuitry. The read block circuitry 502 may generate the read block signal while the write block circuitry 504 may generate the write block signal. As depicted, the read and write block circuitry 502, 504 may each receive selected command history signals which may be used to determine whether to block a given type of received command.

As an example of determining whether to block a given type of received command (e.g., of whether to assert the command block signal for that command), it may be illegal for a read command to be issued to the memory device 100 where a write command was received by the memory device 100 in any of the past six clock cycles or where a read command was received in either the previous clock cycle or three clock cycles previously. Thus, as depicted, the read block circuitry 502 may receive command history signals from the command history circuitry 116 indicating whether write commands were received in the past six clock cycles (Write 1-6), a command history signal indicating whether a read command was received in the previous clock cycle (Read 1), and a command history signal indicating whether a read command was received three cycles previously (Read 3). If any of the command history signals (Write 1-6, Read 1, or Read 3) are asserted (as determined by the OR gates 510, 512, 514, 516), then the read block signal may be asserted. If, however, a write command was not received in the previous six clock cycles and a read command was not received in the previous cycle or three cycles previously, then the read block signal may not be asserted, such that received read commands may not be blocked by the read detect circuitry 402.

As another example of determining whether to block a given type of received command, it may be illegal for a write command to be issued to the memory device 100 where a write command was received by the memory device 100 in the previous clock cycle. Thus, as depicted, the write block circuitry 504 may receive a command history signal from the command history circuitry 116 indicating whether a write command was received in the previous clock cycle (Write 1). If the command history signal Write 1 is asserted (as determined by the OR gate 518), then the write block signal may be asserted (optionally no OR gate may be used, or equivalent logic may be used). If, however, a write command was not received in the previous clock cycle, then the write block signal may not be asserted, such that received write commands may not be blocked by the write detect circuitry 404.

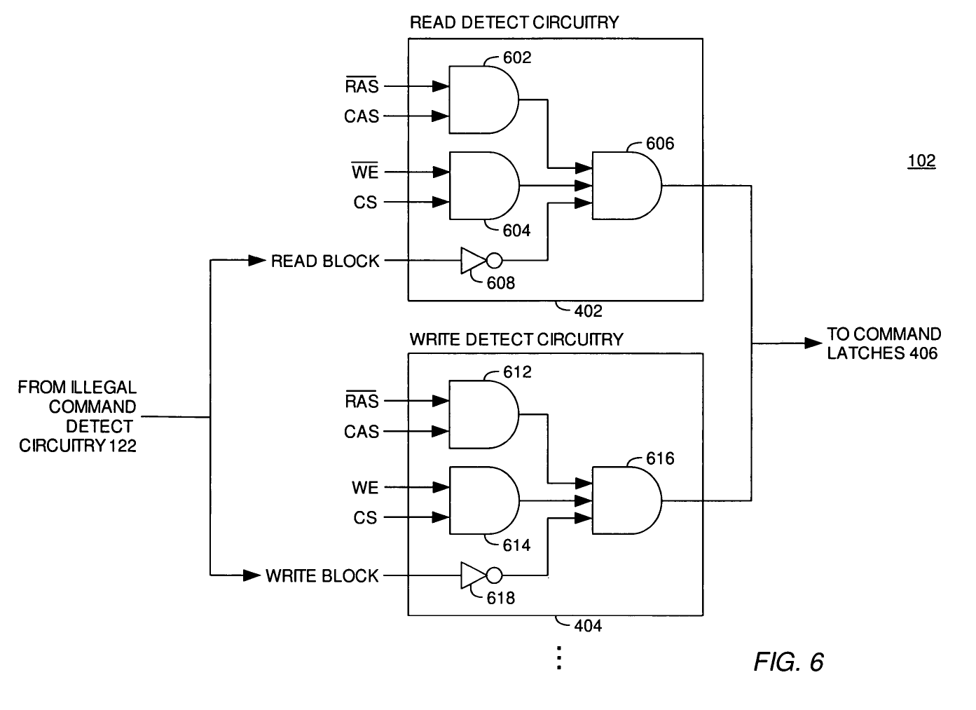

FIG. 6 is a block diagram depicting exemplary read and write command detect circuitry 402, 404 in a command decoder 102 according to one embodiment of the invention. As depicted, the read detect circuitry 402 may receive the command signals R̅A̅S̅, CAS, W̅E̅, and CS as well as the read block signal. If each of the received command signals R̅A̅S̅, CAS, W̅E̅, and CS is asserted and if the read block signal is not asserted (e.g., as determined by AND gates 602, 604, 606 and NOT gate 608), then the read detect circuitry 402 may assert a signal indicating that a read command has been successfully received and decoded. If, however, each of the received command signals R̅A̅S̅, CAS, W̅E̅ and CS is asserted and the read block signal is also asserted, then the read detect circuitry 402 may not assert a signal indicating a read command has been received, thereby effectively blocking the read command from being decoded and processed by the memory device 100. Also, if any of the received signals R̅A̅S̅, CAS, W̅E̅, and CS is not asserted, then a read command has not been received, and the read signal may not be asserted, regardless of the value of the read block signal.

Similarly, with respect to the write detect circuitry 404, if each of the command signals R̅A̅S̅, CAS, WE, and CS received by the write detect circuitry 404 is asserted and if the write block signal is not asserted (e.g., as determined by AND gates 612, 614, 616 and NOT gate 618), then the write detect circuitry 404 may assert a signal indicating that a write command has been successfully received and decoded. If, however, each of the received command signals R̅A̅S̅, CAS, WE, and CS is asserted and the write block signal is also asserted, then the write detect circuitry 404 may not assert a signal indicating a write command has been received, thereby effectively blocking the write command from being decoded and processed by the memory device 100. Also, if any of the received signals R̅A̅S̅, CAS, WE, and CS is not asserted, then a write command has not been received, and the write signal may not be asserted, regardless of the value of the write block signal.

Thus, when the read block signal or write block signal is detected by the read command detect circuitry 402 or the write command detect circuitry 404, respectively, a received read command or a received write command may not be decoded, respectively (e.g., the read command signal may not be asserted or the write command signal may not be asserted).

While described above with respect to read command history which is used to determine whether received read or write commands are legal, embodiments of the invention may use the history of any type(s) of commands to determine whether any type(s) of received commands are illegal. Also, the illegal command detect circuitry may also utilize received address bits, control register settings, error signals, and/or any other signals available in the memory device 100 to determine whether commands received by the command decoder 102 are illegal. Furthermore, as known to those skilled in the art, the decoder circuitry may contain other circuitry such a delay circuitry and other control circuitry.

### CONCLUSION

As described above, embodiments of the invention provide command history circuitry which may be utilized to record the history of commands received by a memory device. The command history may then be provided to illegal command detect circuitry in a command decoder and used to determine whether commands received by the command decoder are illegal. If the commands are not illegal, the command decoder may provide decoded commands to other circuitry in the memory device. If the commands are illegal, the command decoder may not provide decoded commands to other circuitry in the memory device.

While described above with respect to command decoding and illegal command detection in memory devices, embodiments of the invention may be utilized with any type of device which receives and decodes commands, such as processors and memory controllers. Also, while specific examples of illegal commands are provided above with specific logic directed to blocking those commands, embodiments of the invention may be utilized with any type of illegal commands and any appropriate logic. Similarly, depicted logical arrangements of circuitry described above are merely exemplary and not intended to be limiting. For example, the illegal command detect circuitry 122 is depicted within the command decoder 102. However, such circuitry 122 need not be contained within the command decoder 102 (e.g., such circuitry 122 may be located outside of the command decoder 122).

While the foregoing is directed to embodiments of the present invention, other and further embodiments of the invention may be devised without departing from the basic scope thereof, and the scope thereof is determined by the claims that follow.

What is claimed is:

1. A method for detecting illegal commands, the method comprising:
receiving one or more first commands;
recording a history of the received one or more first commands;
receiving one or more second commands at a command decoder;
determining if the one or more second commands are illegal commands, wherein the history of the one or more received first commands is used to determine if the one or more second commands are illegal commands; and
if the one or more second commands are illegal commands, preventing the command decoder from decoding and issuing decoded one or more second commands corresponding to the received one or more second commands.

2. The method of claim 1, further comprising:
decoding the received one or more first commands; and
recording the decoded one or more first commands in the history.

3. The method of claim 2, further comprising:
storing each of the received one or more first commands in a corresponding latch in a chain of one or more latches, wherein a relative position of each of the received one or more first commands in the chain of one or more latches indicates how recently each of the received one or more first commands was received.

4. The method of claim 3, further comprising:
propagating values corresponding to each of the received one or more first commands from the corresponding latch to a subsequent latch in the chain of one or more latches during each clock cycle, wherein each value indicates whether a corresponding command of a particular type was received at a corresponding clock cycle.

5. The method of claim 3, further comprising:
determining whether a received one of the one or more first commands may affect whether the one or more second commands are illegal commands;
if so, maintaining the received one of the one or more first commands in the history of the one or more received first commands; and
if not, removing the received one of the one or more first commands from the history of the one or more received first commands.

6. The method of claim 5, wherein removing the received one of the one or more first commands from the history of the one or more received first commands comprises:
issuing a signal to circuitry in a chain of latches which prevents the received one of the one or more first commands from being propagated through the chain of latches.

7. An integrated circuit device comprising:
a command decoder configured to receive one or more first commands and a second command;
command history circuitry configured to store a history of the received one or more first commands; and
illegal command detect circuitry configured to:
determine if the second command is an illegal command, wherein the history of the received one or more first commands is used to determine if the second command is an illegal command; and
if the second command is an illegal command, issue a signal which, when detected by the command decoder, prevents the command decoder from decoding and issuing a decoded command signal for the second command.

8. The integrated circuit device of claim 7, further comprising:
control circuitry, wherein the control circuitry is configured to issue signals implementing a command when a decoded command signal for the command is received.

9. The integrated circuit device of claim 7, wherein the command history circuitry comprises:
a series of latches configured to store the received one or more first commands.

10. The integrated circuit device of claim 9, wherein series of latches is configured to store the received one or more first commands as decoded command signals, wherein each decoded command signal corresponds to one of the received one or more first commands.

11. The integrated circuit device of claim 9, wherein the command history circuitry is configured to:
store a signal corresponding to each one of the received one or more first commands in a corresponding latch in the series of latches, wherein the corresponding latch indicates a previous cycle in which each one of the received one or more first commands was received.

12. The integrated circuit device of claim 11, wherein the command history circuitry is further configured to:
propagate values corresponding to transfer each one of the received one or more first commands from the corresponding latch to a subsequent latch in the series of latches during each clock cycle, wherein each value indicates whether a corresponding command of a particular type was received at a corresponding clock cycle.

13. The integrated circuit device of claim 9, wherein the command history circuitry is further configured to:
determine whether a received one of the one or more first commands may affect whether the second commands is an illegal command;
if so, maintain the received one of the one or more first commands in the history of the one or more received first commands; and
if not, remove the received one of the one or more first commands from the history of the one or more received first commands.

14. The integrated circuit device of claim 13, the command history circuitry further comprises:
circuitry configured to remove the received one of the one or more first commands from the history of the one or more received first commands by issuing a signal to propagation circuitry in a chain of latches which prevents the received one of the one or more first commands from being propagated through the chain of latches.

15. A memory device comprising:
a command decoder configured to receive one or more first commands and a second command;
command history circuitry configured to store a history of the received one or more first commands;
one or more memory arrays;
control circuitry, wherein the control circuitry is configured to issue signals accessing the one or more memory arrays when a decoded command signal for a command is received; and
illegal command detect circuitry configured to:
determine if the second command is an illegal command, wherein the history of the received one or more first commands is used to determine if the second command is an illegal command; and
if the second command is an illegal command, issue a signal which, when detected by the command decoder, prevents the command decoder from decoding and issuing a decoded command signal for the second command.

16. The memory device of claim 15, wherein the one or more first commands and the second command are each latched at a corresponding rising edge of a command clock signal.

17. The memory device of claim 15, wherein the command history circuitry comprises:
a series of latches configured to store the received one or more first commands.

18. The memory device of claim 17, wherein series of latches is configured to store the received one or more first commands as decoded command signals, wherein each decoded command signal corresponds to one of the received one or more first commands.

19. The memory device of claim 15, wherein the illegal command detect circuitry is configured to:
assert a command block signal to the decoder indicating that the second command is an illegal command wherein illegal command detect circuitry is configured to assert the signal when the received one or more first commands matches a predefined sequence of commands which indicates that the second command is an illegal command.

20. The memory device of claim 15, wherein the command history circuitry is configured to only store command history for received commands which are legal.

21. The memory device of claim 15, wherein the command history circuitry is configured to:
detect a received access command;
determine if the received access command accesses a closed memory bank;
if not, store command history for the received access command; and
if so, discard the received access command without storing the command history for the received access command.

22. The memory device of claim 15, wherein the illegal command detect circuitry is configured to identify the second command as an illegal command when the history of the received one or more first commands indicates that a specified sequence of commands was previously received.

23. An integrated circuit device comprising:
a means for decoding configured to receive one or more first commands and a second command;
means for storing command history configured to store a history of the received one or more first commands; and
means for detecting illegal commands configured to:
determine if the second command is an illegal command, wherein the history of the received one or more first commands is used to determine if the second command is an illegal command; and
if the second command is an illegal command, issue a signal which, when detected by the means for decoding, prevents the means for decoding from decoding and issuing a decoded command signal for the second command.

24. The integrated circuit device of claim 23, wherein the means for storing command history comprises:
a series of means for latching configured to store the received one or more first commands.

25. The integrated circuit device of claim 24 wherein series of means for latching is configured to store the received one or more first commands as decoded command signals, wherein each decoded command signal corresponds to one of the received one or more first commands.

26. The integrated circuit device of claim 24, wherein the means for storing command history is configured to:
store a signal corresponding to each one of the received one or more first commands in a corresponding latch in the series of means for latching, wherein the corresponding means for latching indicates a previous cycle in which each one of the received one or more first commands was received.

27. The integrated circuit device of claim 26, wherein the means for storing command history is further configured to:
propagate values corresponding to transfer each one of the received one or more first commands from the corresponding means for latching to a subsequent means for latching in the series of means for latching during each clock cycle, wherein each value indicates whether a corresponding command of a particular type was received at a corresponding clock cycle.

28. The integrated circuit device of claim 24, wherein the means for storing command history is further configured to:
determine whether a received one of the one or more first commands may affect whether the second commands is an illegal command;
if so, maintain the received one of the one or more first commands in the history of the one or more received first commands; and
if not, remove the received one of the one or more first commands from the history of the one or more received first commands.

29. The integrated circuit device of claim 28, the means for storing command history further comprises:
circuitry configured to remove the received one of the one or more first commands from the history of the one or more received first commands by issuing a signal to means for propagating in a chain of means for latching which prevents the received one of the one or more first commands from being propagated through the chain of means for latching.
